(19) United States
(12) Patent Application Publication
(10) Pub. No.: US 2023/0400006 A1
(43) Pub. Date: Dec. 14, 2023

(54) WAVE TURBINE

(71) Applicant: Salvatore Deiana, San Francisco, CA (US)

(72) Inventor: Salvatore Deiana, San Francisco, CA (US)

(21) Appl. No.: 18/305,623

(22) Filed: Apr. 24, 2023

Related U.S. Application Data
(63) Continuation-in-part of application No. 18/177,574, filed on Mar. 2, 2023, now Pat. No. 11,802,536.
(60) Provisional application No. 63/351,678, filed on Jun. 13, 2022.

(51) Int. Cl. F03B 17/06; F03B 13/18; F03B 17/02

(52) U.S. Cl. CPC F03B 17/064; F03B 13/183; F03B 17/02; F05B 2220/705; F05B 2220/706

(57) ABSTRACT

An electrical generating apparatus has a structure with a weighted base with a first and a second vertical tube enclosure spaced apart, a turbine having an axis, a length and a plurality of buckets facing in a direction substantially tangent to an outer edge of the circular shape, and generators in the vertical tube enclosures driven by shafts of the turbine through walls of the tube enclosures, wherein, with the apparatus stationary on a seafloor on the weighted base, both wave action and tidal currents turn the turbine that drives the generators.

### CROSS-REFERENCE TO RELATED APPLICATIONS

The present case is a continuation-in-part of co-pending application Ser. No. 18/177,574, filed Mar. 2, 1923, which case claims priority to provisional patent application 63/351,678, filed Jun. 13, 2022. All disclosure of the parent cases is incorporated herein at least by reference.

### BACKGROUND OF THE INVENTION

### 1. Field of the Invention

The present invention is in the technical field of electricity generation and pertains more particularly to methods and apparatus for generating electricity from wave motion.

### 2. Description of Related Art

It is well known that electric generation by burning fossil fuels releases carbon into the Earth's atmosphere in gaseous forms. This circumstance, along with other situations releasing carbon into the atmosphere has resulted in demonstrable global warming.

It is also well known that to reduce or eliminate global warming it is necessary to generate electricity from renewable sources like solar and wind energy, and both of these sources have been aggressively exploited. Another renewable source that has not been exploited to such an extent is wave energy. Apparatus is known that may be used in flowing water, such as a river or spill from a dam, and also in current induced by changes in tides, but such apparatus requires that there be continuing current in one direction. Waves do not produce such a current.

What is needed in the art is apparatus that may harness the changing motion of water in wave phenomenon.

### BRIEF SUMMARY OF THE INVENTION

In one embodiment of the present invention an electrical generating apparatus is provided, comprising a vertically-oriented structure having a weighted base with a first and a second vertical tube enclosure spaced apart on the weighted base, a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine, and a first generator in the first vertical tube enclosure with a first drive shaft coupled to the first shaft of the turbine passing through a wall of the first vertical tube enclosure such that motion of the turbine turns the generator, and a second generator in the second vertical tube enclosure with a second drive shaft coupled to the second shaft of the turbine passing through a wall of the second vertical tube enclosure such that motion of the turbine turns the generator, wherein, with the apparatus stationary on a seafloor on the weighted base, both wave action and tidal currents turn the turbine that drives the generators.

In one embodiment the apparatus further comprises a wind driven air pump powered by a wind vane positioned above water level, pumping air through a passage into buckets on a side of the turbine where the buckets face downward, providing torque. Also, in one embodiment the apparatus further comprises a plurality of turbines implemented between the first and the second vertical tube enclosures, spaced apart vertically, each turbine driving a generator in each of the first and the second vertical tube enclosures. In one embodiment the apparatus further comprises electrical circuitry and conductors arranged to carry electricity generated away from the apparatus to remote points. And in one embodiment the apparatus further comprises attachment elements adapted to manipulate the apparatus in placement and retrieval.

In one embodiment an electrical generating apparatus is provided, comprising a vertically-oriented structure having a weighted base with a first and a second vertical tube enclosure spaced apart on the weighted base, a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine, a first generator in the first vertical tube enclosure with a first drive shaft coupled to the first shaft of the turbine passing through a wall of the first vertical tube enclosure such that motion of the turbine turns the generator, a second generator in the second vertical tube enclosure with a second drive shaft coupled to the second shaft of the turbine passing through a wall of the second vertical tube enclosure such that motion of the turbine turns the generator, and a protective structure completely surrounding the vertical tube enclosures and the turbine implemented between the vertical tube enclosures, the protective structure open above and below. With the apparatus stationary on a seafloor on the weighted base, only wave action turns the that drive the generators, the protective structure shielding the apparatus from wave action.

In one embodiment the apparatus further comprises a wind driven air pump powered by a wind vane positioned above water level, pumping air through a passage into buckets on a side of the turbine where the buckets face downward, providing torque. Also, in one embodiment the apparatus further comprises a plurality of turbines implemented between the first and the second vertical tube enclosures, spaced apart vertically, each turbine driving a generator in each of the first and the second vertical tube enclosures.

In one embodiment the apparatus further comprises electrical circuitry and conductors arranged to carry electricity generated away from the apparatus to remote points. And in one embodiment the apparatus further comprises attachment elements adapted to manipulate the apparatus in placement and retrieval.

In another aspect of the invention a method for driving a generator to produce electricity is provided, comprising implementing a vertically-oriented structure having a weighted base with a first and a second vertical tube enclosure spaced apart on the weighted base, a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine, and a first generator in the first vertical tube enclosure with a first drive shaft coupled to the first shaft of the turbine passing through a wall of the first vertical tube enclosure such that motion of the turbine turns the first generator, and a second generator in the second vertical tube enclosure with a second drive shaft coupled to the second shaft of the turbine passing through a wall of the second vertical tube enclosure such that motion of the turbine turns the second generator, and placing the structure stationary on a seafloor on the weighted base, such that both wave action and tidal currents turn the turbine that drives the generators.

### BRIEF DESCRIPTION OF THE SEVERAL VIEWS OF THE DRAWINGS

FIG. 1 is a perspective view of a wheel useful for driving a generator in the prior art.

FIG. 2 is a perspective view of a wheel useful for converting wave motion in an embodiment of the invention.

FIG. 3 is a perspective view of an apparatus based on a conveyor belt with buckets in an embodiment of the invention.

FIG. 4 is a perspective view of a self-contained wave energy generating unit in an embodiment of the invention.

FIG. 5 is a perspective cutaway view illustrating gearing through which a generator is driven in an embodiment of the invention.

FIG. 6 is a perspective view of a wind driven air pump providing air to drive a conveyor in an embodiment of the invention.

FIG. 7 is a perspective view of a bucketed wave turbine in an embodiment of the invention.

FIG. 8 is a partial section view of the bucketed wave turbine of FIG. 7.

FIG. 9 is a perspective view of a turbine set formed from bucketed wave turbines.

FIG. 10 is a perspective view of a turbine set and enclosure in an embodiment of the invention.

FIG. 11 is a perspective view of a generating assembly in an embodiment of the invention.

FIG. 12A is a diagram illustrating effect of wave action on a turbine set in an embodiment of the invention.

FIG. 12B is a diagram illustrating effect of tide currents on a turbine set in an embodiment of the invention.

FIG. 12C is a diagram illustrating effect of injected air on a turbine set in an embodiment of the invention.

FIG. 13 is a perspective view of an electrical generating apparatus with an outer barrier.

FIG. 14 is a perspective view of the generating apparatus of FIG. 13 from a different viewpoint.

FIG. 15 is a perspective view of another electrical generating apparatus with an outer barrier.

FIG. 16 is a perspective view of the generating apparatus of FIG. 15, sitting on a water-filled bell in an embodiment of the invention.

FIG. 17 is a perspective view of a multitasking U-Generator in an embodiment of the invention.

### DETAILED DESCRIPTION OF THE INVENTION

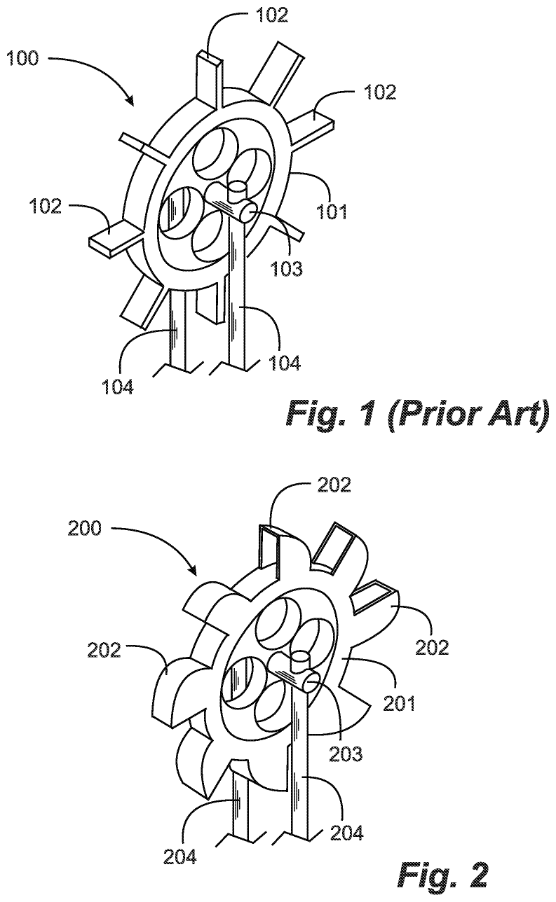

FIG. 1 is a perspective view of an apparatus 100 comprising a wheel 101 with extending paddles 102 useful for driving a turbine in the prior art. In this example wheel 101 turns on an axis of a shaft 103, the shaft supported by two vertical supports 104. In one implementation the wheel may be a stator and the shaft a stator of an electric generator. In another implementation shaft 103 may rotate from torque provided by the wheel and the rotating shaft may be harnessed with gearing apparatus to turn an electric generator.

It will be apparent to the skilled person that if the entire wheel with paddles is totally immersed in water, either still or in moving current, the wheel will not turn. In use such an apparatus, sometimes termed a paddle wheel, is positioned with just the paddles on a lower extremity immersed in a flowing current, which causes the wheel to rotate. Such paddle wheels are also used as mill wheels with falling water hitting the paddles on one side, turning the wheel.

FIG. 2 is a perspective view of an apparatus 200 with a wheel 201 useful for converting wave motion in an embodiment of the invention. Wheel 201 has a plurality of buckets 202 spaced around the periphery of the wheel, with open faces of the buckets facing in a direction substantially tangent to a rim of the wheel. The wheel, as in FIG. 1, turns on an axis 203 supported by vertical supports 204 in this example.

It is well known that wave motion differs from liquid current in that the motion of a wave is repetitive upward and downward motion of the water. It may be seen that with apparatus 200 in a vertical aspect as shown, a bucket on one side of wheel 201 faces down and the corresponding bucket on the other side faces upward. It will be apparent to the skilled person that if apparatus 200 is immersed completely under water in a location where there is significant wave motion, as a wave rises the water motion will effect the buckets on one side facing down more strongly than the buckets on the other side of the wheel facing upward. Then as the wave falls the water motion will effect the buckets facing upward more strongly than the buckets facing down. So the wave motion, either rising or falling, will tend to turn the wheel in the same direction providing torque at the axis 203.

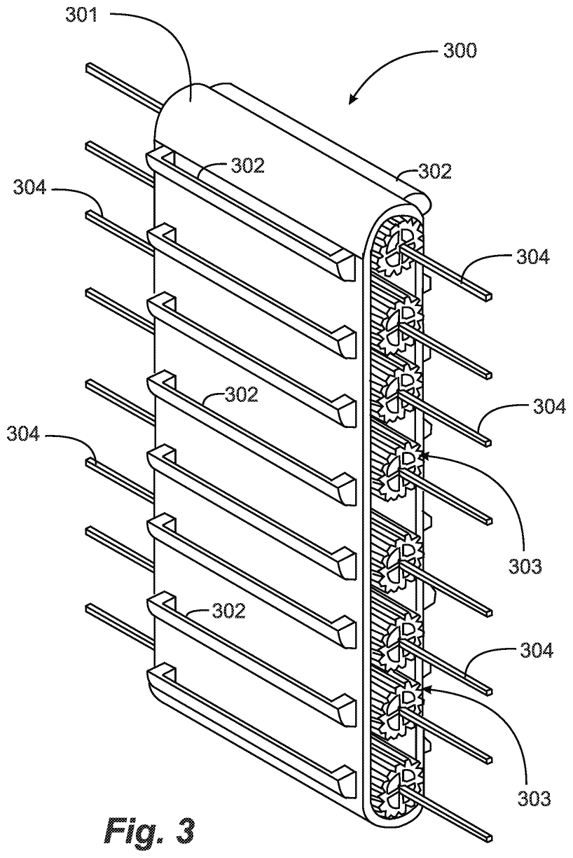

FIG. 3 is a perspective view of an apparatus 300 in in embodiment of the invention to maximize torque and efficiency in converting wave motion to rotary energy that may be harnesses to create electricity. Apparatus 300 comprises a vertically oriented conveyor belt 301 operating around a plurality of geared rollers 303 with shafts 304 extending from both ends of each gear wheel. Conveyor belt 301 has a plurality of extended buckets 302 oriented across the width of the conveyor belt and spaced along the length of the conveyor belt. The long buckets 302 are joined to the conveyor belt such that the openings to the buckets all face in the same direction, so the buckets face upward on one side of the conveyor belt and downward on the other side. This circumstance follows the purpose of apparatus 200 of FIG. 2. Immersed in water with wave action, the wave action either upward or downward will urge the conveyor belt in the same direction and turn the plurality of geared rollers 303 always in the same rotary direction, which will turn the shafts 304 all in the same rotary direction. Shafts 304 may be used to drive generators through geared mechanisms not shown to produce electricity.

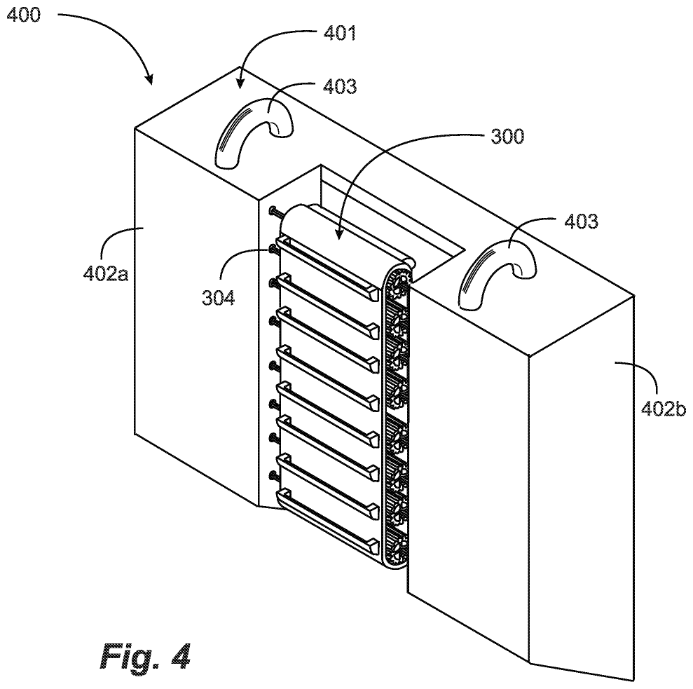

FIG. 4 is a perspective view of a self-contained wave energy generating unit 400 in an embodiment of the invention. Unit 400 has a sealed cabinet 401 with two opposite portions 402a and 402b and a conveyor belt apparatus 300 integrated between the opposite portions of the cabinets. Shafts 304 from each end of each of the gear units within the conveyor belt pass into portions 402a and 402b through sealed openings and connect within the sealed housings to electrical generators (not shown). Hooks 403 are for lifting and placing generating unit 400 to be immersed. Waves operate on the buckets of the conveyor belt, turning the gear wheels which turn generators, which may be through a gear train, and electricity is generated. Wiring carrying generated current from the generating unit 400 is not shown.

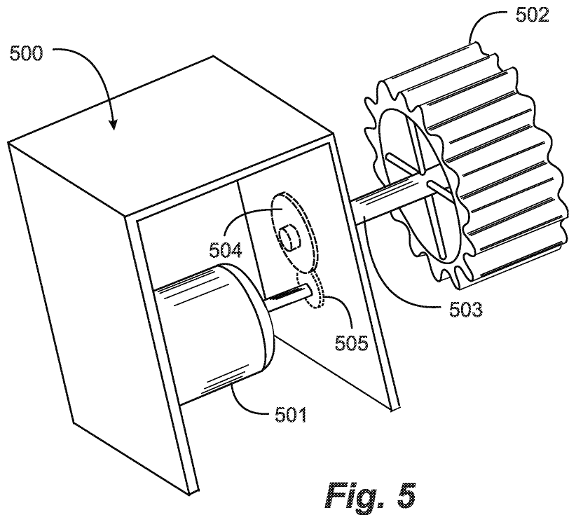

FIG. 5 is a partially cutaway view of an enclosure 500 which represents one portion of enclosure 401 of FIG. 4. One generator 501 with shaft is shown in the enclosure connected to a gear 505 driven by a larger gear 504 that is driven through a sealed opening by shaft 503 by one roller 502. Roller 502 represents one roller 303 as shown in FIG. 2 in conveyor belt 301. Shaft 503 in FIG. 5 represents one shaft 304 from FIG. 3 and FIG. 4. As wave motion drives conveyor belt 301 shaft 503 turns gear 504 that turns gear 505 that drives the generator. In the finished unit a plurality of rollers 303 drive a plurality of generators on both sides of the conveyor belt.

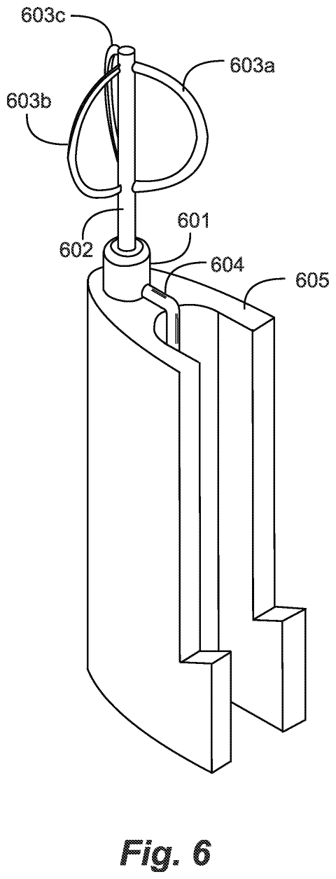

In operation there is thought to be a small time period wherein the motion of the water transitions from downward to upward in a wave. The inventor has provided an addition driving force that helps the conveyor to keep moving during this short period. FIG. 6 illustrates a wind driven air pump 601 having a shaft 602 with wind vanes 603a, 603b and 603c. Wind turns shaft 602 and the air pump delivers air via a line 604 to a distribution lines proximate conveyor 300. The distribution lines deliver the air into the extended buckets 302 on the side of the conveyor where the buckets face downward. The air provides a motive force to the buckets to help drive the conveyor. Structure 605 represents structure connecting to sealed cabinet 401.

In another aspect of the invention bucketed wave turbines are used with a housing enclosing generators without incorporating a conveyor belt as illustrated by FIG. 3 and described with reference to FIG. 3 above.

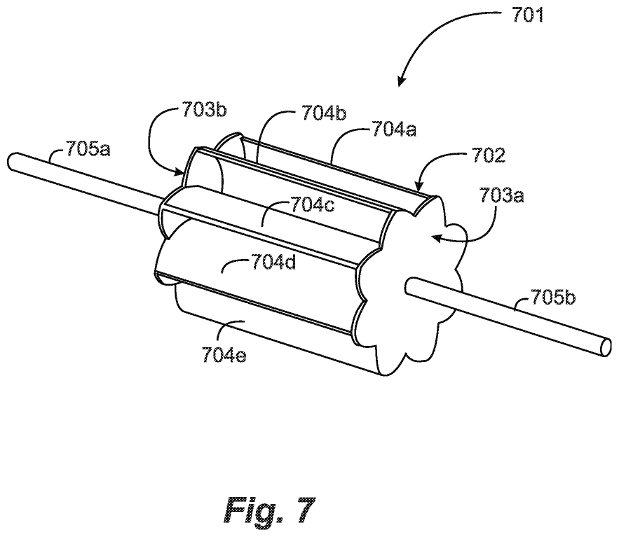

FIG. 7 is a perspective view of a wave turbine 701 in an embodiment of the invention, comprising a bucketed turbine assembly 702 formed by end plates 703a and 703b joined to curved plates 704a through 704e visible in this view, and other curved plates not visible in this view. Assembly 702 provides buckets with openings tangential to the periphery of the assembly, much as illustrated for wheel 201 and described above referencing FIG. 2.

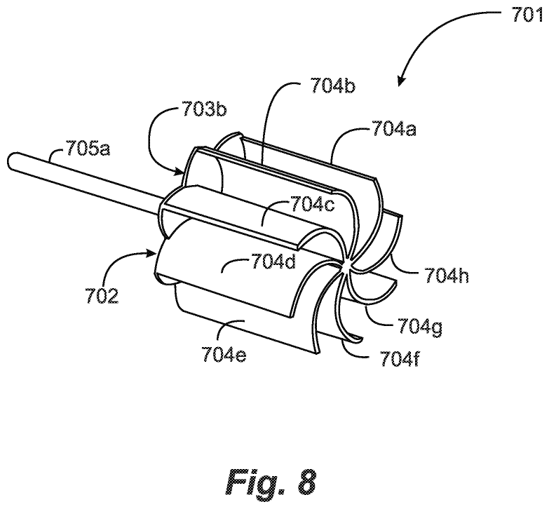

FIG. 8 is a partial section view of the bucketed turbine 701 of FIG. 7. A section is taken at a right angle to a central axis of shaft 705a through the curved plates, such that additional curved plated 704f, 704g and 704h are visible. In this example there are eight curved plates 704a through 704h, arranged at 45-degree intervals around the central axis of the shaft. In alternative embodiments there might be more or fewer curved plates forming a different number of buckets.

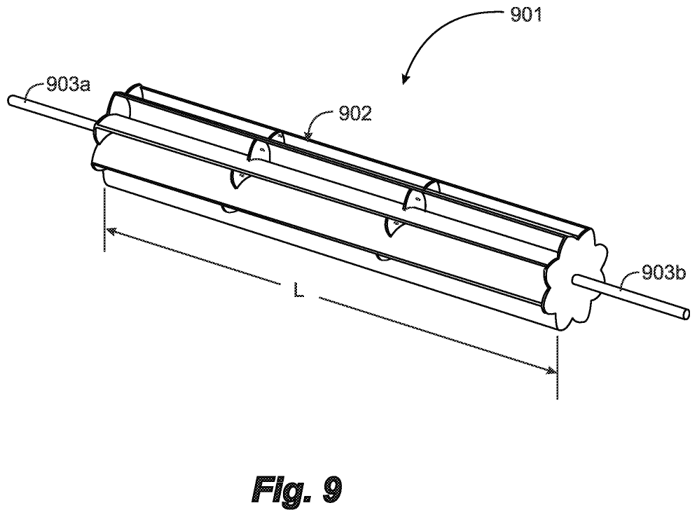

FIG. 9 is a perspective view of a turbine set 901 that may be formed in this example from a plurality of bucketed wave turbines 902 joined end to end. Set 901 in this example has a length L which may vary in different embodiments by joining more or fewer of the bucketed turbines shown in FIG. 7. In alternative embodiments turbine set 901 may be constructed in original length L with reinforcements at convenient positions along the length. An important feature is to have a wave turbine with tangentially-facing buckets of a substantial length L to maximize force effect of wave action or current action on the buckets.

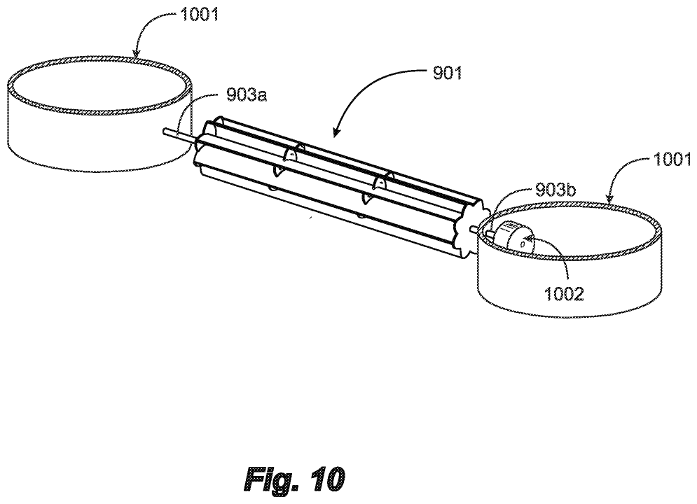

FIG. 10 is a perspective view of one turbine set 901 integrated with an enclosure 1001 holding generators 1002 that are driven by shafts 903a and 903b of turbine set 901 passing through side walls of enclosure 1001. Enclosure 1001 in this circumstance is a U-shaped structure having two vertical sections, and the cylindrical sections shown on each side of the turbine set are separate sections of the single U-shaped enclosure, that is illustrated and described below in more detail.

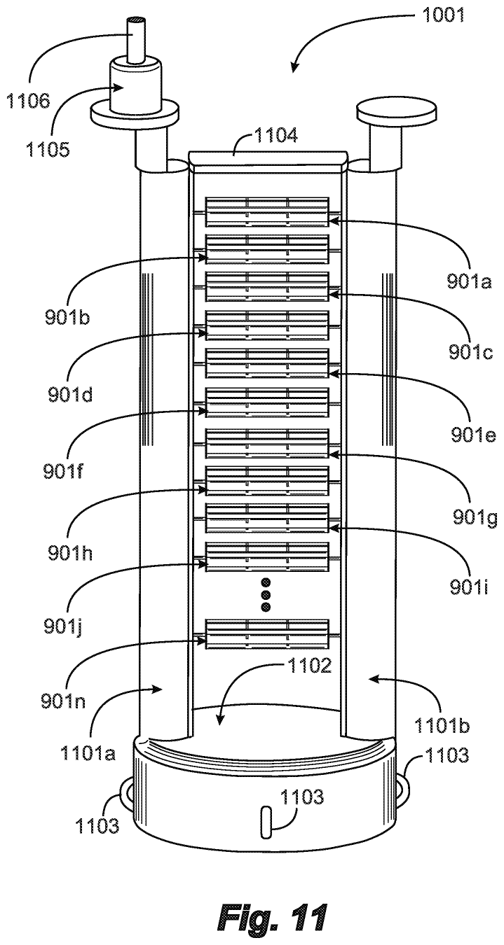

FIG. 11 is a perspective view of a generating assembly 1001 comprising a base unit 1102 having two vertically extending enclosures 1101a and 1101b. A plurality of turbine sets 901a through 901n span between enclosures 1101a and 1101b with shafts from the turbine sets passing through sealed openings through sidewalls of the enclosures and engaging generators mounted within the enclosures. This arrangement is illustrated in FIG. 10 showing one turbine set and sections of the enclosure. Hooks 1103 are for managing and moving the assembly, and span 1104 at the top reinforces the structure by connecting the opposite enclosures at the top. An air pump 1105 above one of the enclosures is driven by a shaft 1106 from a wind turbine, not shown in the figure. The wind turbine may be as illustrated in FIG. 6, and there may be conduits providing air from the air pump to beneath the turbines to provide additional torque to the turbines.

The number of turbine sets incorporated in generator assembly 1001, each turbine set driving two generators, one in each enclosure 1101a and 1101b, may vary depending on the height of the vertical enclosures and the stability of the assembly. There may in one embodiment be just one turbine set, and in another a substantial number of turbine sets.

Although not detailed in FIG. 11 the generators may be driven by gearing mechanisms, as indicated in FIG. 5. Suitable wiring connections, also not shown, are provided for providing electricity generated from the generators to remote points, either from the upper portions of the assembly or along the sea floor upon which the assembly may be supported.

In operation base 1102 of an assembly 1001 may be weighted by water or other suitable material, such as sand or stone or metal, and the assembly may be positioned on a seafloor in a location where there is significant wave action or tide action or both.

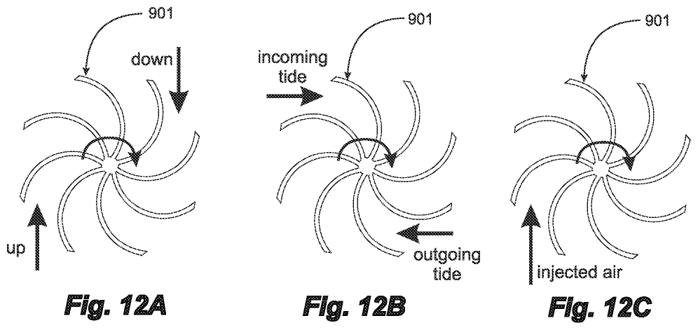

FIGS. 12A, 12B and 12C illustrate the effect of wave action, tide action and injected air on turbine sets. FIG. 12A represents wave action on a turbine set 901. Water movement in a wave down or up will tend to turn turbine set 901 clockwise as shown. FIG. 12B represents action according to incoming and outgoing tide, which also tends to rotate the turbine set clockwise. FIG. 12B represents action of air injected under the turbine set, which also tends to turn the turbine set clockwise.

So, it may be clear to the skilled person that a generating assembly 1001 set in a position on a seafloor that has wave action or tide action or both will cause the plurality of turbine sets to rotate in one direction to turn generators to produce electricity.

In another aspect of the invention a assembly is provided that is shielded in a manner to be typhoon proof. The actual turbines are implemented between enclosures housing generators as already illustrated and described, but an outer barrier is added to create a calm pond around the structure to protect the structure from battering waves. This apparatus excludes effect of tidal currents and harnesses only the vertical action of waves.

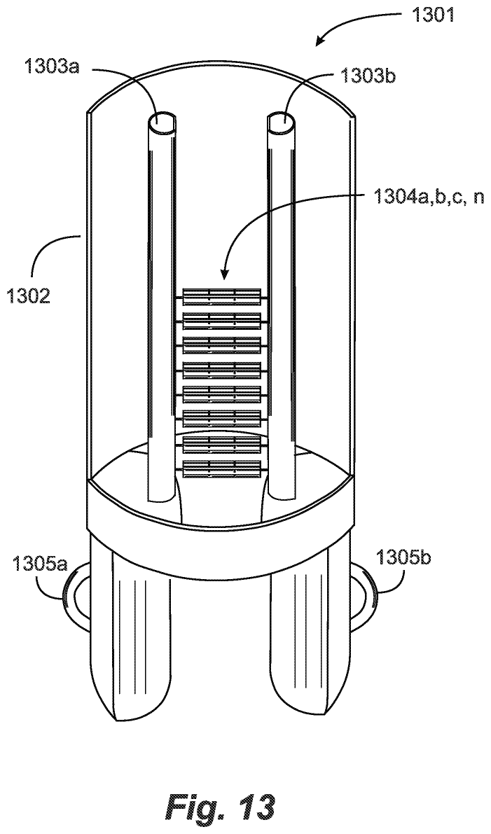

FIG. 13 a perspective view of a generating apparatus 1301 that has an outer protective structure 1302 that protects elements within that structure from battering by tidal action and waves. There are two enclosures 1303a and 1303b within the outer protective structure, equivalent to enclosures 1101a and 1101b of FIG. 11, described above. A plurality of turbines 1304 a through n are arranged between enclosures 1303a and 1303b such that water moving vertically within protective structure 1302 turns the turbines. Rings 1305a and b are for manipulating the apparatus in placement and retrieval if needed. The apparatus rests on the seafloor as described above for the apparatus of FIG. 11.

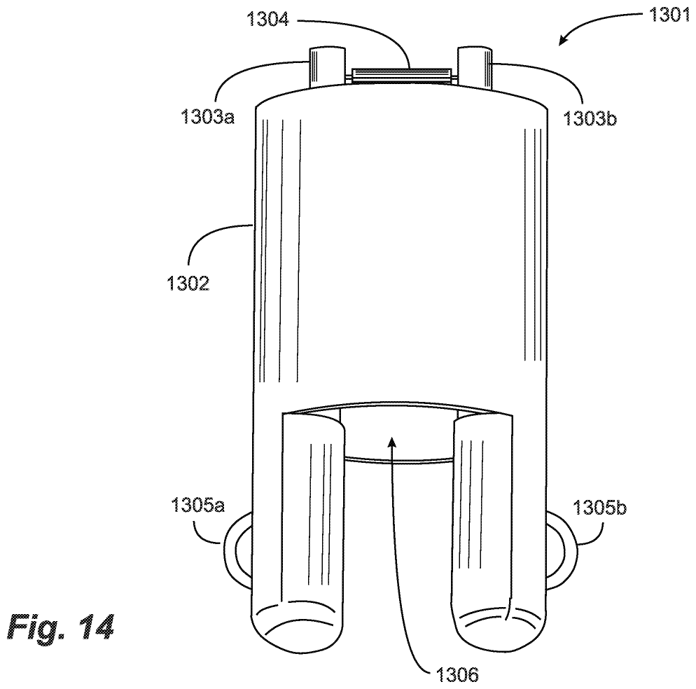

FIG. 14 is the generating apparatus of FIG. 13 from a different viewpoint, particularly to show that the bottom of protective structure 1302 has a full opening 1306 so water may pass vertically withing the protective structure to turn turbines 1304.

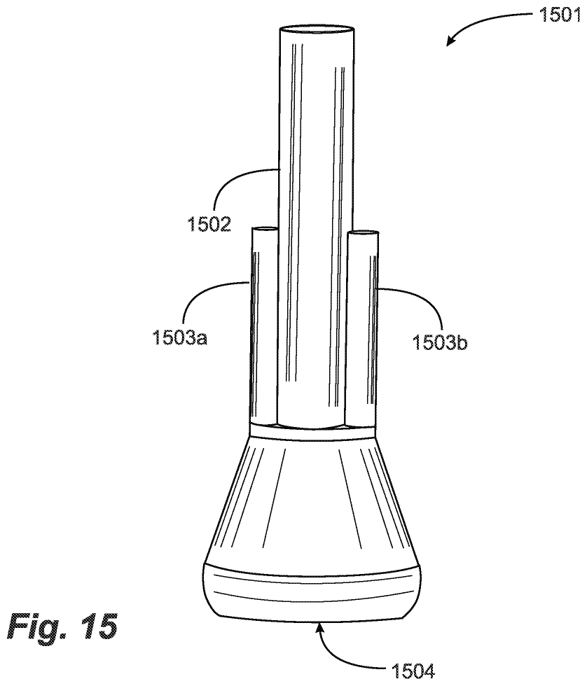

FIG. 15 is a perspective view of another generating apparatus 1501, similar to that of FIGS. 13 and 14, in which the protective structure 1502 is shaped differently. In this version enclosures 1503a and 1503b house generators and a plurality of turbines are arranged vertically in portion 1502, with shafts from the turbines passing through sealed openings in the enclosures 1503a and 1503b. As in the earlier version referencing FIGS. 13 and 14 the bottom and top of the protective structure are fully open so water may move vertically within to drive the turbines.

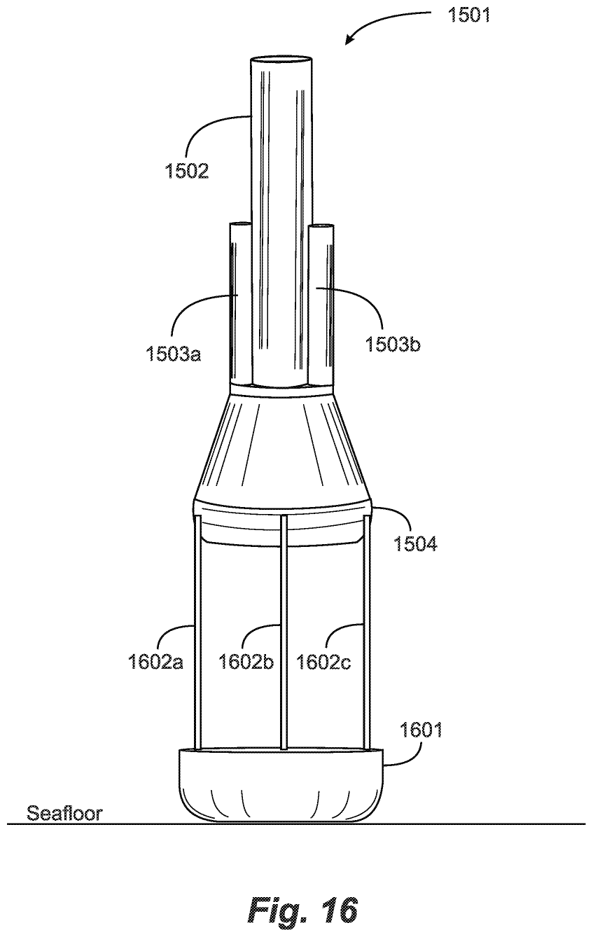

FIG. 16 is a perspective view of generating apparatus 1501 from FIG. 15, sitting on a water-filled bell. The generating apparatus is anchored by cables 1602a, 1602b and 1602c to a submerged water bag 1601 that is anchored loosely to the seafloor. The generating apparatus is kept afloat at the sea surface independent of the tides.

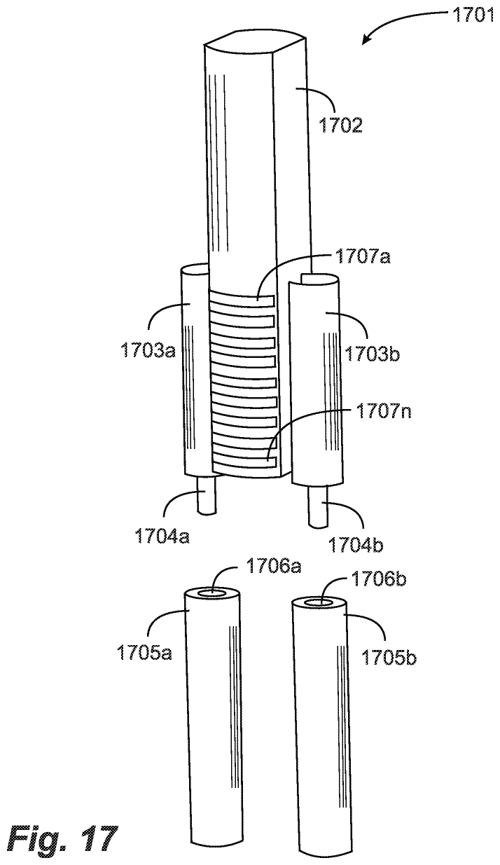

FIG. 17 is a perspective view of a multitasking U-Generator 1701. Protective structure 1702 has a series of slots 1707a trough 1707n that allow tidal current to pass into and through the protective cover to turn turbines (not shown) that span the width of protective cover 1702 and turn generators in tubes 1703a and 1703b. by shafts from the turbines that pass through sealed openings in the walls of the tubes. The turbines are also tuned by current from wave motion.

Generating apparatus 1701 has posts 1704a and 1704b that engage holes 1706a and 1706b in suction piles 1705a and 1705b engaged into the sea floor.

The skilled person will understand that the embodiments illustrated and described above are exemplary only and not limiting to the scope of the invention. There are many alterations that may be made in the embodiments described within the scope of the invention. The scope of the invention is limited only by the claims.

1. An electrical generating apparatus, comprising:
a vertically-oriented structure having a weighted base with a first and a second vertical tube enclosure spaced apart on the weighted base;
a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine;
a first generator in the first vertical tube enclosure with a first drive shaft coupled to the first shaft of the turbine passing through a wall of the first vertical tube enclosure such that motion of the turbine turns the generator; and
a second generator in the second vertical tube enclosure with a second drive shaft coupled to the second shaft of the turbine passing through a wall of the second vertical tube enclosure such that motion of the turbine turns the generator,
wherein, with the apparatus stationary on a seafloor on the weighted base, both wave action and tidal currents turn the turbine that drives the generators.

2. The electrical generating apparatus of claim 1 further comprising a wind driven air pump powered by a wind vane positioned above water level, pumping air through a passage into buckets on a side of the turbine where the buckets face downward, providing torque.

3. The electrical generating apparatus of claim 1 further comprising a plurality of turbines implemented between the first and the second vertical tube enclosures, spaced apart vertically, each turbine driving a generator in each of the first and the second vertical tube enclosures.

4. The electrical generating apparatus of claim 1 further comprising electrical circuitry and conductors arranged to carry electricity generated away from the apparatus to remote points.

5. The electrical generating apparatus of claim 1 further comprising attachment elements adapted to manipulate the apparatus in placement and retrieval.

6. An electrical generating apparatus, comprising:
a vertically-oriented structure having a weighted base with a first and a second vertical tube enclosure spaced apart on the weighted base;
a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine;
a first generator in the first vertical tube enclosure with a first drive shaft coupled to the first shaft of the turbine passing through a wall of the first vertical tube enclosure such that motion of the turbine turns the generator;
a second generator in the second vertical tube enclosure with a second drive shaft coupled to the second shaft of the turbine passing through a wall of the second vertical tube enclosure such that motion of the turbine turns the generator, and
a protective structure completely surrounding the vertical tube enclosures and the turbine implemented between the vertical tube enclosures, the protective structure open above and below;
wherein, with the apparatus stationary on a seafloor on the weighted base, only wave action turns the that drive the generators, the protective structure shielding the apparatus from wave action.

7. The electrical generating apparatus of claim 6 further comprising a wind driven air pump powered by a wind vane positioned above water level, pumping air through a passage into buckets on a side of the turbine where the buckets face downward, providing torque.

8. The electrical generating apparatus of claim 6 further comprising a plurality of turbines implemented between the first and the second vertical tube enclosures, spaced apart vertically, each turbine driving a generator in each of the first and the second vertical tube enclosures.

9. The electrical generating apparatus of claim 6 further comprising electrical circuitry and conductors arranged to carry electricity generated away from the apparatus to remote points.

10. The electrical generating apparatus of claim 6 further comprising attachment elements adapted to manipulate the apparatus in placement and retrieval.

11. A method for driving a generator to produce electricity, comprising:
implementing a vertically-oriented structure having a weighted base with a first and a second vertical tube enclosure spaced apart on the weighted base, a turbine having an axis, a length and a circular shape orthogonal to the axis, with curved panels proceeding from the axis, spaced around the axis, forming a plurality of buckets facing in a direction substantially tangent to an outer edge of the circular shape, the turbine having a first shaft extending in a direction of the axis from a first end and a second shaft extending in the direction of the axis from a second end of the turbine, and a first generator in the first vertical tube enclosure with a first drive shaft coupled to the first shaft of the turbine passing through a wall of the first vertical tube enclosure such that motion of the turbine turns the first generator, and a second generator in the second vertical tube enclosure with a second drive shaft coupled to the second shaft of the turbine passing through a wall of the second vertical tube enclosure such that motion of the turbine turns the second generator, and
placing the structure stationary on a seafloor on the weighted base, such that both wave action and tidal currents turn the turbine that drives the generators.

12. The method of claim 11 wherein the vertically-oriented structure further comprises a protective structure surrounding the vertically-oriented structure, the protective structure open top and bottom, such that the vertically-oriented structure is protected from lateral currents and responds only to vertical currents, the method further comprising placing the structures stationary on a seafloor on the weighted base, such that only wave action currents turn the turbine that drives the generators.
